(19) United States
(12) Patent Application Publication
(10) Pub. No.: US 2013/0097166 A1
(43) Pub. Date: Apr. 18, 2013

(54) Determining Demographic Information for a Document Author

(71) Applicants: Patrick W. Fink, Charlotte, NC (US); Kristin E. McNeil, Charlotte, NC (US); Philip E. Parker, York, SC (US)

(72) Inventors: Patrick W. Fink, Charlotte, NC (US); Kristin E. McNeil, Charlotte, NC (US); Philip E. Parker, York, SC (US)

(73) Assignee: INTERNATIONAL BUSINESS MACHINES CORPORATION, Armonk, NY (US)

(21) Appl. No.: 13/271,306

(22) Filed: Oct. 12, 2011

(51) Int. Cl. G06F 7/00

(52) U.S. Cl. 707/737; 707/E17.089

(57) ABSTRACT

According to one embodiment of the present invention, a system determines a demographic group associated with a document, and comprises a computer system including at least one processor. The system analyzes sample documents from one or more demographic groups to determine a demographic profile for each of the demographic groups based on one or more textual features within the sample documents. The one or more textual features within a document are evaluated and a document profile is generated based on the one or more textual features. The document profile is compared to the demographic profiles to identify the demographic group associated with the document. Embodiments of the present invention further include a method and computer program product for determining a demographic group associated with a document in substantially the same manner described above.

### BACKGROUND

1. Technical Field

Present invention embodiments relate to document analysis, and more specifically, to determining demographic information for a document author based on text analytics.

2. Discussion of the Related Art

Demographic data has become increasingly important for businesses, intelligence agencies, and governments. For example, determination of demographic information (e.g., location, gender, age range, etc.) of corporation customers enables understanding of the profile of customers utilizing the corporation products. This information may be used to target marketing campaigns. With respect to an intelligence agency, a demographic profile may assist in criminal investigation or intelligence profiling. In addition, governments may tailor provided services based on demographic information.

### BRIEF SUMMARY

According to one embodiment of the present invention, a system determines a demographic group associated with a document, and comprises a computer system including at least one processor. The system analyzes sample documents from one or more demographic groups to determine a demographic profile for each of the demographic groups based on one or more textual features within the sample documents. The one or more textual features within a document are evaluated and a document profile is generated based on the one or more textual features. The document profile is compared to the demographic profiles to identify the demographic group associated with the document. Embodiments of the present invention further include a method and computer program product for determining a demographic group associated with a document in substantially the same manner described above.

### BRIEF DESCRIPTION OF THE SEVERAL VIEWS OF THE DRAWINGS

FIG. 1 is a diagrammatic illustration of an example computing environment for use with an embodiment of the present invention.

FIG. 2 is a procedural flow chart illustrating a manner in which demographic profiles are generated from sample documents according to an embodiment of the present invention.

FIG. 3 is a procedural flow chart illustrating a manner in which a document is analyzed and compared to generated demographic profiles to determine demographic information for a document author according to an embodiment of the present invention.

### DETAILED DESCRIPTION

Present invention embodiments determine demographic information for an author of a document (e.g., text or other file containing any type of text in any spoken language (e.g., speech transcript, web or other pages, word processing files, spreadsheet files, presentation files, electronic mail, multimedia, etc.)). A collection of documents produced by members of a specific demographic group is processed. For example, a collection of documents authored by males of ages 20-25 years and from the southeast region may be utilized to form a document collection and generate a demographic profile for this demographic group. The documents within the document collection are analyzed by one or more analysis techniques to extract textual features common to the demographic group. Each individual analysis technique generates an analytic score for a corresponding feature, where the analytic scores for respective features from each of the documents within the collection are combined to produce respective profile scores for storage within a demographic score table. The resulting set of profile scores represents the demographic profile (or writing characteristics or style) for the demographic group associated with the document collection. Once demographic profiles are determined for various collections of documents (representing various demographic groups), a document is analyzed to determine document profile scores (representing the writing characteristics or style of the author). The document profile scores are compared against the generated profile scores of each demographic profile in order to determine the most likely demographic group of the document author.

Present invention embodiments utilize text analytics to perform text analysis of a document in order to interpret the document text and determine demographic information pertaining to the document author (e.g., author age range, gender, education level, geographic location, etc.). This demographic information may be used for targeting marketing campaigns, criminal profiles, and other governmental civic campaigns in an effort to deliver more personalized information and produce higher return on marketing expense. In addition, the demographic information about the document author may be placed alongside other textual information ascertained from the text by an analytics product (e.g., IBM Content Analytics, etc.).

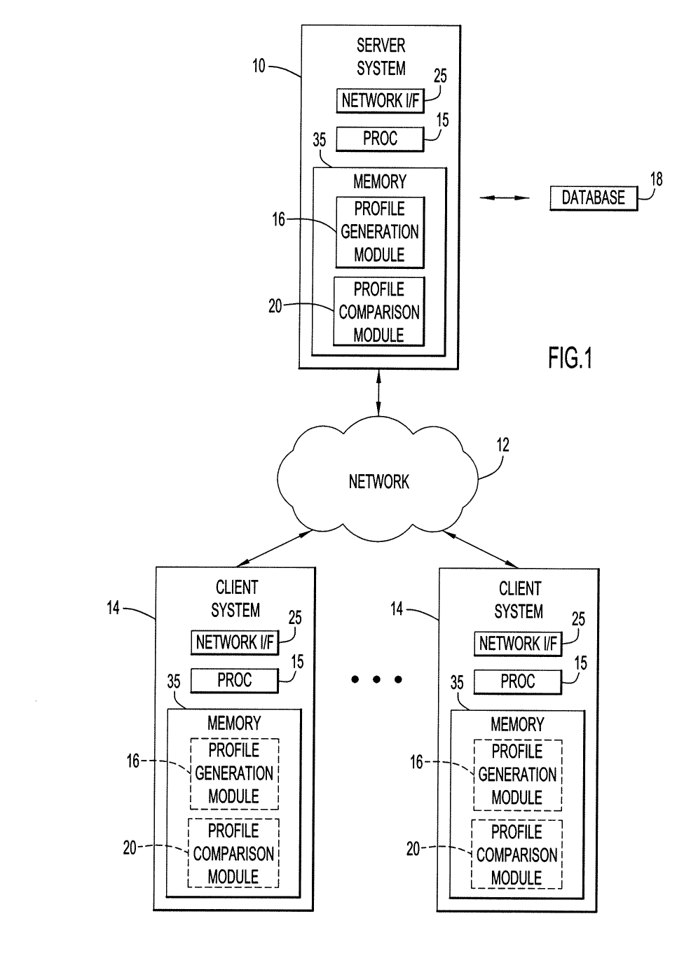

An example environment for use with present invention embodiments is illustrated in FIG. 1. Specifically, the environment includes one or more server systems 10, and one or more client or end-user systems 14. Server systems 10 and client systems 14 may be remote from each other and communicate over a network 12. The network may be implemented by any number of any suitable communications media (e.g., wide area network (WAN), local area network (LAN), Internet, Intranet, etc.). Alternatively, server systems 10 and client systems 14 may be local to each other, and communicate via any appropriate local communication medium (e.g., local area network (LAN), hardwire, wireless link, Intranet, etc.).

Client systems 14 enable users to submit documents (e.g., documents for document collections, documents for analysis to determine demographic information, etc.) to server systems 10 to determine demographic information pertaining to document authors. The server systems include a profile generation module 16 to generate demographic profiles, and a profile comparison module 20 to analyze documents and compare document features to the generated demographic profiles to determine demographic information for the authors of the documents. A database system 18 may store various information for the analysis (e.g., generated profiles, profile scores, sample collections of documents, etc.). The database system may be implemented by any conventional or other database or storage unit, may be local to or remote from server systems 10 and client systems 14, and may communicate via any appropriate communication medium (e.g., local area network (LAN), wide area network (WAN), Internet, hardwire, wireless link, Intranet, etc.). The client systems may present a graphical user (e.g., GUI, etc.) or other interface (e.g., command line prompts, menu screens, etc.) to solicit information from users pertaining to the desired documents and analysis, and may provide reports including analysis results (e.g., text analytics, profile scores, demographic information pertaining to the document author, etc.).

Server systems 10 and client systems 14 may be implemented by any conventional or other computer systems preferably equipped with a display or monitor, a base (e.g., including at least one processor 15, one or more memories 35 and/or internal or external network interfaces or communications devices 25 (e.g., modem, network cards, etc.)), optional input devices (e.g., a keyboard, mouse or other input device), and any commercially available and custom software (e.g., server/communications software, profile generation module, profile comparison module, browser/interface software, etc.).

Alternatively, one or more client systems 14 may analyze documents to determine demographic information pertaining to document authors when operating as a stand-alone unit. In a stand-alone mode of operation, the client system stores or has access to the data (e.g., generated profiles, profile scores, sample collections of documents, etc.), and includes profile generation module 16 and profile comparison module 20 to perform the demographic analysis on documents. The graphical user (e.g., GUI, etc.) or other interface (e.g., command line prompts, menu screens, etc.) solicits information from a corresponding user pertaining to the desired documents and analysis, and may provide reports including analysis results (e.g., text analytics, profile scores, demographic information pertaining to the document author, etc.).

Profile generation module 16 and profile comparison module 20 may include one or more modules or units to perform the various functions of present invention embodiments described below. The various modules (e.g., profile generation module, profile comparison module, etc.) may be implemented by any combination of any quantity of software and/or hardware modules or units, and may reside within memory 35 of the server and/or client systems for execution by processor 15.

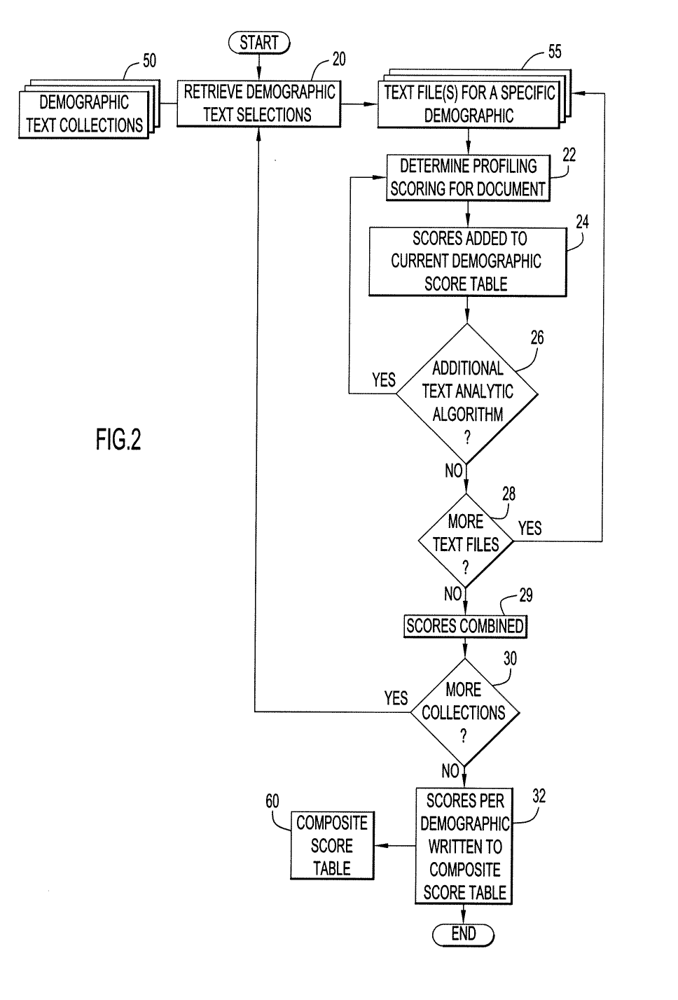

A manner in which demographic profiles are generated by profile generation module 16 (e.g., via server system 10 and/or client system 14) from sample documents according to an embodiment of the present invention is illustrated in FIG. 2. Initially, a collection of documents 55 with authors from a specific demographic group is retrieved at step 20 from document collections 50. The document collections are preferably stored within database system 18. Each collection within document collections 50 is associated with (or has documents produced by members of) a corresponding demographic group. For example, a retrieved collection of documents may be authored by males of ages 20-25 years and from the southeast region. The particular document collection to retrieve may be specified by a user via a user interface, and may be produced or authored by any group with any desired demographics or characteristics (e.g., age range, gender, education level, geographic location, any combinations thereof, etc.).

One or more analytic scores are determined for each document within retrieved document collection 55. In particular, text analytics are determined for a document to produce the analytic scores. An individual analysis technique is applied to the document within the retrieved document collection to measure a document feature or text analytic, and generate an analytic score for the document with respect to that particular document feature or text analytic at step 22. The analytic score is stored within a demographic score table at step 24 that preferably resides within database system 18.

The individual analysis technique may determine various document features or text analytics. For example, document text typically contains characteristics with respect to word usage, word sequence, composition and layouts, common spelling and grammatical mistakes, vocabulary richness, hyphenation, and punctuation. Common document features typically include lexical, syntactical, structural, content specific, and idiosyncratic. Lexical features include characteristics of characters and words or tokens (e.g., frequency of letters, frequency of capital letters, total number of characters per token, character count per sentence, word length distribution, words per sentence, vocabulary richness, etc.). Syntactic features refer to the distribution of function words (e.g., “upon, “thus”, “above”) and punctuation, while structural features measure the overall layout and organization of text within documents (e.g., average paragraph length, number of paragraphs per document, various file extensions, fonts, sizes, colors, etc.). Content specific features relate to a collection of certain keywords and phrases on certain topics commonly found within a demographic group and may vary. Idiosyncratic features include misspellings, grammatical mistakes, deliberate author choices or cultural features (e.g., relating to use of words, etc.). The idiosyncratic features may be extracted via use of conventional spelling and grammar checking tools and dictionaries.

An individual analysis technique may be utilized to extract a feature (e.g., one or more of lexical, syntactical, structural, content specific, idiosyncratic types of features, etc.) from the document (e.g., frequency of letters, frequency of capital letters, total number of characters per token, character count per sentence, word length distribution, words per sentence, vocabulary richness, distribution of function words, punctuation, average paragraph length, number of paragraphs per document, various file extensions, fonts, sizes, colors, misspellings, grammatical mistakes, deliberate author choices or cultural features, etc.). A resulting analytic score is determined for the corresponding feature by the analysis technique, and may be based on the actual feature measurement (e.g., frequency of letters, frequency of capital letters, total number of characters per token, character count per sentence, word length distribution, words per sentence, vocabulary richness, distribution of function words, punctuation, average paragraph length, number of paragraphs per document, various file extensions, fonts, sizes, colors, misspellings, grammatical mistakes, deliberate author choices or cultural features, etc.). For example, the actual feature measurement may provide a numeric result that serves as the resulting analytic score, or the actual feature measurement may be converted to a desired value range (e.g., 0-100, 0-10, 0-1, etc.) via any conventional or other technique (e.g., normalization, look-up table, mathematical formula or operation, etc.), especially with respect to a non-numeric measurement of a feature (e.g., punctuation, presence of specific content, etc.). The resulting analytic score is stored in the demographic score table.

One or more analysis techniques may be applied to the document to generate corresponding analytic scores each associated with the corresponding document feature or text analytic being measured (e.g., frequency of letters, frequency of capital letters, total number of characters per token, character count per sentence, word length distribution, words per sentence, vocabulary richness, distribution of function words, punctuation, average paragraph length, number of paragraphs per document, misspellings, grammatical mistakes, deliberate author choices or cultural features, etc.). Accordingly, when additional analysis techniques are present as determined at step 26, a successive analysis technique is applied to the document at step 22 to generate a corresponding analytic score for the document feature or text analytic associated with that technique in substantially the same manner described above. The resulting analytic score is stored in the demographic score table at step 24. The analysis techniques are applied to the document in succession until score values for each technique have been generated as determined at step 26. Thus, a document is associated with one or more analytic scores each corresponding to an individual document feature or text analytic.

By way of example, analysis techniques are preferably applied to the document to measure two or three features or characteristics across two or more different feature types (e.g., lexical, syntactical, structural, content specific, idiosyncratic types of features, etc.) and produce corresponding analytic scores for the demographic score table. However, any quantity of analysis techniques may be applied to the document to measure any desired document features or text analytics.

When additional documents are present within retrieved document collection 55 as determined at step 28, one or more score values are generated for the remaining documents within retrieved document collection 55 for storage in the demographic score table in substantially the same manner described above.

Once analytic scores for each of the documents in retrieved document collection 55 have been generated as determined at step 28, the analytic scores for the documents are combined to produce profile scores that are stored in the demographic score table at step 29. In particular, a profile score for a specific document feature or text analytic is determined by combining the analytic scores for that specific document feature or text analytic determined for each of the documents within the document collection. The analytic scores for the specific document feature or text analytic may be combined in any desired fashion to produce the profile score for that document feature or text analytic (e.g., average or weighted average of profile scores, etc.). This is performed for each document feature or text analytic measured by the individual analysis techniques to produce a set of profile scores for the retrieved collection of documents. The set of profile scores represents a specific demographic profile (or identifiable writing characteristics or style) pertaining to the demographic group authoring the retrieved document collection.

When additional document collections are available as determined at step 30, the next document collection 55 pertaining to a different demographic group is retrieved and analyzed in substantially the same manner described above to generate a demographic profile (e.g., a set of profile scores for document features or text analytics of the documents within the subsequent document collection) for that demographic group. The demographic profiles for each document collection are stored in a composite score table 60 at step 32. The composite score table preferably resides in database system 18.

Profile generation module 16 (e.g., via server system 10 and/or client system 14) produces the demographic profiles for each demographic group represented by (or authoring) a collection within document collections 50. The sample document collection to generate a demographic profile for a corresponding demographic group preferably contains at least 1,000 documents; however, samples containing any quantity of documents may be utilized to generate the demographic profiles.

The generated demographic profiles are utilized to determine demographic information for an author of a document. Basically, a document is analyzed to identify the demographic profile most closely associated with the document based on a comparison of a document profile (or writing characteristics or style of the document) with the generated demographic profiles (or writing characteristics or style of the demographic groups). The demographic group associated with the identified demographic profile is considered to be the demographic group of the document author.

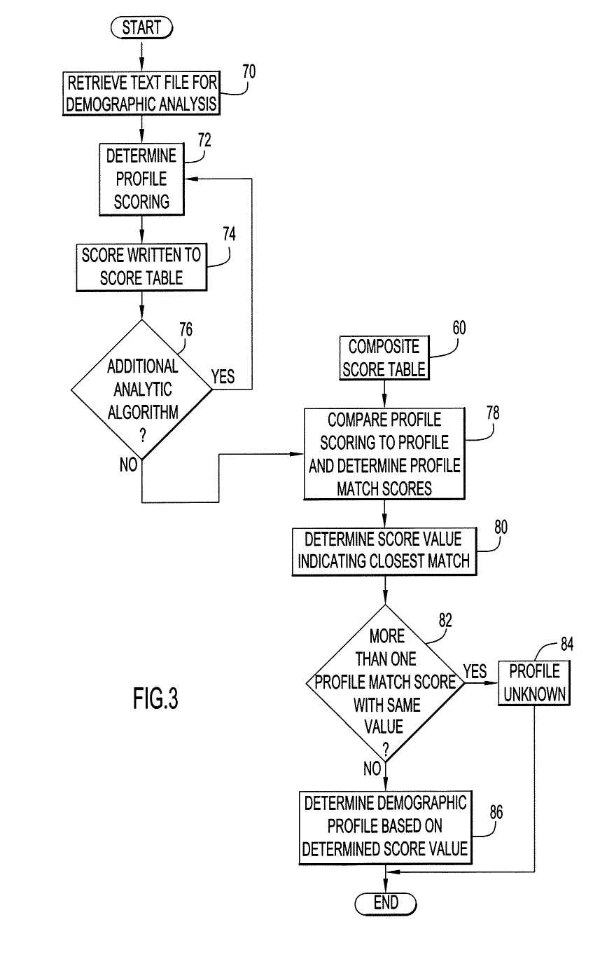

A manner in which profile comparison module 20 (e.g., via server system 10 and/or client system 14) analyzes and compares a document to generated demographic profiles to determine demographic information for a document author according to an embodiment of the present invention is illustrated in FIG. 3. Initially, a document is retrieved for analysis at step 70 to determine demographic information for the document author. The document may be stored within database system 18, or locally on the server and/or client system performing the analysis. The particular document to retrieve may be specified by a user via a user interface.

One or more profile scores are determined for the retrieved document to produce a document profile that includes a form substantially similar to the form of the generated demographic profiles. In particular, an individual analysis technique is applied to the retrieved document to extract a feature (e.g., one or more of lexical, syntactical, structural, content specific, idiosyncratic types of features, etc.) from the document (e.g., frequency of letters, frequency of capital letters, total number of characters per token, character count per sentence, word length distribution, words per sentence, vocabulary richness, distribution of function words, punctuation, average paragraph length, number of paragraphs per document, various file extensions, fonts, sizes, colors, misspellings, grammatical mistakes, deliberate author choices or cultural features, etc.). A resulting profile score is determined for the corresponding feature by the analysis technique at step 72, and may be based on the actual feature measurement (e.g., frequency of letters, frequency of capital letters, total number of characters per token, character count per sentence, word length distribution, words per sentence, vocabulary richness, distribution of function words, punctuation, average paragraph length, number of paragraphs per document, various file extensions, fonts, sizes, colors, misspellings, grammatical mistakes, deliberate author choices or cultural features, etc.). For example, the actual feature measurement may provide a numeric result that serves as the resulting profile score, or the actual feature measurement may be converted to a desired value range (e.g., 0-100, 0-10, 0-1, etc.) via any conventional or other technique (e.g., normalization, look-up table, mathematical formula or operation, etc.), especially with respect to a non-numeric measurement of a feature (e.g., punctuation, presence of specific content, etc.). The profile score is stored within a document score table at step 74. The document score table preferably resides within database system 18.

One or more analysis techniques may be applied to the retrieved document to generate corresponding profile scores each associated with the corresponding document feature or text analytic being measured (e.g., frequency of letters, frequency of capital letters, total number of characters per token, character count per sentence, word length distribution, words per sentence, vocabulary richness, distribution of function words, punctuation, average paragraph length, number of paragraphs per document, various file extensions, fonts, sizes, colors, misspellings, grammatical mistakes, deliberate author choices or cultural features, etc.). These analysis techniques are substantially the same techniques employed to generate the demographic profiles described above. Accordingly, when additional analysis techniques are present as determined at step 76, a successive analysis technique is applied to the document at step 72 to generate a corresponding profile score for the document feature or text analytic associated with that technique in substantially the same manner described above. The resulting profile score is stored in the document score table at step 74. The analysis techniques are applied to the document in succession until profile scores for each technique have been generated as determined at step 76. Thus, a document is associated with one or more profile scores each corresponding to an individual document feature or text analytic.

The set of profile scores represents a document profile (or writing characteristics or style of the document) that is utilized to identify the demographic profile (or demographic group) most closely associated with the document. The document profile (or writing characteristics or style of the document) is compared to the generated demographic profiles (or writing characteristics or style of the demographic groups), and a profile match score is determined for each demographic profile at step 78. In particular, each document feature or text analytic within the document and demographic profiles is assigned a weight value. The weight value may include any suitable value, where a greater weight value generally indicates a greater importance of the corresponding document feature or text analytic for the comparison. Thresholds are further assigned to each of the profile scores of the document and demographic profiles. The thresholds indicate the acceptable deviation or closeness of the profile score within the document profile to a corresponding profile score within a demographic profile. By way of example, the thresholds may indicate an absolute difference between the profile score values, or a percentage difference between the profile score values. However, the thresholds may indicate difference limits in any suitable fashion.

The profile scores within the document profile are compared to the corresponding scores within a generated demographic profile to identify the document features or text analytics with differences in the profile scores satisfying the assigned thresholds. The weight values of the identified document features or text analytics satisfying the assigned thresholds are summed to produce the profile match score for the generated demographic profile. The document profile is compared to each generated demographic profile to produce a corresponding profile match score for that generated demographic profile in substantially the same manner described above.

Alternatively, the differences between the corresponding profile scores in the document and demographic profiles may be determined and combined (e.g., summed, averaged, etc.) to determine a profile match score. In this case, the lowest profile match score indicates the demographic profile (or demographic group) most closely associated with the document.

Once the profile match scores are determined, these scores are compared to determine one or more profile match score values indicating the closest match between the document profile and a corresponding generated demographic profile at step 80. This may be accomplished in various manners depending on the technique employed to generate the profile match score. For example, the greatest profile match score may indicate the closest match in the event the technique described above employing weight values is utilized to determine the profile match score. Alternatively, the lowest profile match score may indicate the closest match in the event the technique described above employing actual differences is utilized to determine the profile match score.

When two or more profile match scores having the same score value are identified as indicating the closest match as determined at step 82, this indicates that the document has been associated with more than one demographic profile (or demographic group) and the demographic information for the document author is indicated as being unknown at step 84. The document profile is stored for further processing and/or retrieval within database system 18.

If a single profile match score indicating a closest match is identified as determined at step 82, the demographic group for the document author is determined at step 86. The demographic group for the document author corresponds to the demographic group associated with the demographic profile producing the identified profile match score.

It will be appreciated that the embodiments described above and illustrated in the drawings represent only a few of the many ways of implementing embodiments for determining demographic information for a document author.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., IBM-compatible, laptop, PDA, mobile devices, etc.), and may include any commercially available operating system and any combination of commercially available and custom software (e.g., browser software, communications software, server software, profile generation module, profile comparison module, etc.). These systems may include any types of monitors and input devices (e.g., keyboard, mouse, voice recognition, etc.) to enter and/or view information.

It is to be understood that the software (e.g., profile generation module, profile comparison module, etc.) of the present invention embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments (e.g., profile generation module, profile comparison module, etc.) may be available on a recordable or computer useable medium (e.g., magnetic or optical mediums, magneto-optic mediums, floppy diskettes, CD-ROM, DVD, memory devices, etc.) for use on stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., documents, document collections, analytic and profile scores, demographic and document score tables, composite score table, demographic and document profiles, etc.). The database system may be implemented by any number of any conventional or other databases, data stores or storage structures (e.g., files, databases, data structures, data or other repositories, etc.) to store information (e.g., documents, document collections, analytic and profile scores, demographic and document score tables, composite score table, demographic and document profiles, etc.). The database system may be included within or coupled to the server and/or client systems. The database systems and/or storage structures may be remote from or local to the computer or other processing systems, and may store any desired data (e.g., documents, document collections, analytic and profile scores, demographic and document score tables, composite score table, demographic and document profiles, etc.). Further, the various tables (e.g., demographic score table, document score table, composite score table, etc.) may be implemented by any conventional or other data structures (e.g., files, arrays, lists, stacks, queues, etc.) to store information, and may be stored in any desired storage unit (e.g., database, data or other repositories, etc.).

Present invention embodiments may be utilized for determining any desired demographic information (e.g., age range, culture, geographic location, education level, gender, any combinations thereof, etc.) for any type of document (e.g., speech transcript, web or other pages, word processing files, spreadsheet files, presentation files, electronic mail, multimedia, etc.) containing text in any spoken language (e.g. English, Spanish, French, Japanese, etc.). The demographic information may pertain to one or more authors or producers of a document.

The sample size for generating the demographic profiles may include any desired quantity of any types of documents that include at least one text portion. The demographic profiles may be associated with groups having any desired demographic characteristics (e.g., age range, culture, geographic location, education level, gender, any combinations thereof, etc.), and may be based on any quantity of any desired document features (e.g., lexical, syntactical, structural, content specific, and/or idiosyncratic types of features including frequency of letters, frequency of capital letters, total number of characters per token, character count per sentence, word length distribution, words per sentence, vocabulary richness, distribution of function words, punctuation, average paragraph length, number of paragraphs per document, various file extensions, fonts, sizes, colors, misspellings, grammatical mistakes, deliberate author choices or cultural features, etc.). Present invention embodiments may utilize any conventional or other techniques to measure text analytics within a document.

The analytic scores and profile scores may be determined in any fashion, and include any desired value within any desired value range. For example, the analytic score may be the actual feature measurement, or convert an actual feature measurement to any desired value range (e.g., 0-100, 0-10, 0-1, etc.) via any conventional or other techniques (e.g., normalization, look-up table, mathematical formula or operation, etc.). Non-numeric measurement of a feature (e.g., punctuation, presence of specific content, etc.) may be converted to any desired value range via any conventional or other technique (e.g., frequency of occurrence of a condition, presence or absence of a condition, etc.) to produce an analytic score.

Any quantity of analysis techniques may be applied to documents to generate the document and demographic profiles. The analysis techniques may measure any desired quantity of characteristics, where the measurements may be combined in any fashion to produce the analytic score (e.g., average or weighted average, summation, etc.). The analytic scores of one or more features may be combined in any fashion (e.g., average or weighted average, summation, etc.) to produce a corresponding profile score for a demographic profile. Further, any quantity of analytic scores may be utilized to produce the profile score for a feature of a demographic profile (e.g., any quantity of analytic scores for all or any portion of documents within the collection, etc.).

Any quantity of profile scores from the document and demographic profiles may be compared to produce a profile match score. The profile match score may include any desired value within any desired value range, and be determined based on any desired techniques (e.g., weights, differences, mathematical combination or formula, quantity of close profile scores, etc.). The weights may be of any desired values within any desired value range (e.g., 0-100, 0-10, 0-1, etc.), and may be utilized in any desired fashion to produce a profile match score (e.g., applied to feature measurements or comparisons for a weighted sum, summed, etc.). The thresholds may indicate any desired closeness or acceptable range for profile scores in any desired fashion (e.g., absolute differences, percentage of values, etc.). The profile scores and/or weights may be utilized to determine a profile match score with or without the thresholds (e.g., summation of absolute or weighted differences, etc.).

Any desired criteria may be utilized to identify a demographic profile for a document (e.g., greatest/least profile match score, profile match scores within certain ranges, quantity of close profile scores, etc.). In the event two or more values are identified associating a document with two or demographic profiles, any desired criteria may be utilized to select one of the profiles (e.g., examine specific individual criteria or features, measure and/or examine other features, user selection of one of the identified demographic profiles, etc.).

The present invention embodiments may employ any number of any type of user interface (e.g., Graphical User Interface (GUI), command-line, prompt, etc.) for obtaining or providing information (e.g., documents, document collections, setting weights and/or thresholds, selection of demographic profile, tie-breaking criteria, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The report may include any information arranged in any fashion, and may be configurable based on rules or other criteria to provide desired information to a user (e.g., text analytics, profile scores, demographic information pertaining to the document author, etc.).

The present invention embodiments are not limited to the specific tasks or algorithms described above, but may be utilized for determining demographic or other information (with identifiable characteristics) for any types of documents.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (Java and all Java-based trademarks and logos are trademarks of Sun Microsystems, Inc. in the United States, other countries, or both), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method of determining a demographic group associated with a document comprising:
analyzing sample documents from one or more demographic groups to determine a demographic profile for each of the demographic groups based on one or more textual features within the sample documents;
evaluating the one or more textual features within a document and generating a document profile based on the one or more textual features; and
comparing the document profile to the demographic profiles to identify the demographic group associated with the document.

2. The computer-implemented method of claim 1, wherein analyzing the sample documents includes:
determining one or more profile scores for each of the demographic groups based on the one or more textual features within the sample documents, wherein the profile scores for each demographic group form the demographic profile for that demographic group.

3. The computer-implemented method of claim 2, wherein analyzing the sample documents further includes:
determining an analytic score for each of the textual features within each sample document from a corresponding demographic group; and
combining the analytic scores of respective textual features to determine respective profile scores for the demographic profile of the corresponding demographic group.

4. The computer-implemented method of claim 1, wherein evaluating the one or more textual features within a document includes:
generating one or more profile scores for the document based on the one or more textual features, wherein the profile scores for the document form the document profile for that demographic group.

5. The computer-implemented method of claim 1, wherein comparing the document profile to the demographic profiles includes:
comparing the profile scores of the document profile to the profile scores of the demographic profiles to identify the demographic group associated with the document.

6. The computer-implemented method of claim 5, wherein comparing the profile scores of the document profile to the profile scores of the demographic profiles includes:
determining a profile match score for each demographic profile based on a comparison of the profile scores of the document profile and that demographic profile; and
identifying the profile match score indicating a closest match between the document profile and one of the demographic profiles to identify the demographic group associated with the document.

7. The computer-implemented method of claim 6, wherein weights are assigned to the profile scores of the document and demographic profiles, and determining a profile match score for each demographic profile includes:
applying the weights to results of the comparison of profile scores of the document profile and that demographic profile.

8. The computer-implemented method of claim 6, wherein thresholds are assigned to the profile scores of the document and demographic profiles, and determining a profile match score for each demographic profile includes:
determining a profile match score for each demographic profile based on differences between the profile scores of the document profile and that demographic profile satisfying the thresholds.

9. A system for determining a demographic group associated with a document comprising:
a computer system including at least one processor configured to:
analyze sample documents from one or more demographic groups to determine a demographic profile for each of the demographic groups based on one or more textual features within the sample documents;
evaluate the one or more textual features within a document and generate a document profile based on the one or more textual features; and
compare the document profile to the demographic profiles to identify the demographic group associated with the document.

10. The system of claim 9, wherein analyzing the sample documents includes:
determining one or more profile scores for each of the demographic groups based on the one or more textual features within the sample documents, wherein the profile scores for each demographic group form the demographic profile for that demographic group.

11. The system of claim 10, wherein analyzing the sample documents further includes:
determining an analytic score for each of the textual features within each sample document from a corresponding demographic group; and
combining the analytic scores of respective textual features to determine respective profile scores for the demographic profile of the corresponding demographic group.

12. The system of claim 9, wherein evaluating the one or more textual features within a document includes:
generating one or more profile scores for the document based on the one or more textual features, wherein the profile scores for the document form the document profile for that demographic group.

13. The system of claim 9, wherein comparing the document profile to the demographic profiles includes:
comparing the profile scores of the document profile to the profile scores of the demographic profiles to identify the demographic group associated with the document.

14. The system of claim 13, wherein comparing the profile scores of the document profile to the profile scores of the demographic profiles includes:
determining a profile match score for each demographic profile based on a comparison of the profile scores of the document profile and that demographic profile; and
identifying the profile match score indicating a closest match between the document profile and one of the demographic profiles to identify the demographic group associated with the document.

15. The system of claim 14, wherein weights are assigned to the profile scores of the document and demographic profiles, and determining a profile match score for each demographic profile includes:
applying the weights to results of the comparison of profile scores of the document profile and that demographic profile.

16. The system of claim 14, wherein thresholds are assigned to the profile scores of the document and demographic profiles, and determining a profile match score for each demographic profile includes:
determining a profile match score for each demographic profile based on differences between the profile scores of the document profile and that demographic profile satisfying the thresholds.

17. A computer program product for determining a demographic group associated with a document comprising:
a computer readable storage medium having computer readable program code embodied therewith, the computer readable program code comprising computer readable program code configured to:
analyze sample documents from one or more demographic groups to determine a demographic profile for each of the demographic groups based on one or more textual features within the sample documents;
evaluate the one or more textual features within a document and generate a document profile based on the one or more textual features; and
compare the document profile to the demographic profiles to identify the demographic group associated with the document.

18. The computer program product of claim 17, wherein analyzing the sample documents includes:
determining one or more profile scores for each of the demographic groups based on the one or more textual features within the sample documents, wherein the profile scores for each demographic group form the demographic profile for that demographic group.

19. The computer program product of claim 18, wherein analyzing the sample documents further includes:
determining an analytic score for each of the textual features within each sample document from a corresponding demographic group; and
combining the analytic scores of respective textual features to determine respective profile scores for the demographic profile of the corresponding demographic group.

20. The computer program product of claim 17, wherein evaluating the one or more textual features within a document includes:
generating one or more profile scores for the document based on the one or more textual features, wherein the profile scores for the document form the document profile for that demographic group.

21. The computer program product of claim 17, wherein comparing the document profile to the demographic profiles includes:
comparing the profile scores of the document profile to the profile scores of the demographic profiles to identify the demographic group associated with the document.

22. The computer program product of claim 21, wherein comparing the profile scores of the document profile to the profile scores of the demographic profiles includes:
determining a profile match score for each demographic profile based on a comparison of the profile scores of the document profile and that demographic profile; and
identifying the profile match score indicating a closest match between the document profile and one of the demographic profiles to identify the demographic group associated with the document.

23. The computer program product of claim 22, wherein weights are assigned to the profile scores of the document and demographic profiles, and determining a profile match score for each demographic profile includes:
applying the weights to results of the comparison of profile scores of the document profile and that demographic profile.

24. The computer program product of claim 22, wherein thresholds are assigned to the profile scores of the document and demographic profiles, and determining a profile match score for each demographic profile includes:
determining a profile match score for each demographic profile based on differences between the profile scores of the document profile and that demographic profile satisfying the thresholds.
